(19) United States
(12) Patent Application Publication
(10) Pub. No.: US 2025/0003275 A1
(43) Pub. Date: Jan. 2, 2025

(54) VENT WINDOW OPERATOR

(71) Applicant: ASSA ABLOY Fenestration, LLC, Rochester, NY (US)

(72) Inventors: Mark Thomas HALECKI, Rochester, NY (US); Anthony SEBASTIAN, Rochester, NY (US); Eric RODEMS, Spencerport, NY (US)

(73) Assignee: ASSA ABLOY Fenestration, LLC, Rochester, NY (US)

(21) Appl. No.: 18/666,953

(22) Filed: May 17, 2024

Related U.S. Application Data
(60) Provisional application No. 63/524,129, filed on Jun. 29, 2023.

(51) Int. Cl. E05D 15/44

(52) U.S. Cl. CPC E05D 15/44; E05Y 2201/604; E05Y 2201/624; E05Y 2900/148

(57) ABSTRACT

The present disclosure provides a vent window operator for moving a window vent relative to a window frame that includes a drive assembly having a rotatable drive arm and shoe assembly adaptable for a variety of vent window applications. A hinged shoe is pivotally attached at the distal end of an arm member of the rotatable drive arm. The arm member may include first and second arms that can be attached to form an included angle that can be varied.

### CROSS-REFERENCE TO RELATED APPLICATION

This application claims the benefit of U.S. Provisional Application No. 63/524,129, filed on Jun. 29, 2023. The entire disclosure of the above application is incorporated herein by reference.

### FIELD

The present disclosure relates to a vent window operator having a drive assembly including rotatable drive arm and shoe assembly that is adaptable for a variety of vent window applications.

### BACKGROUND

This section provides background information related to the present disclosure and is not necessarily prior art.

Vent operator assemblies may be employed in casement-type or projection-type window assemblies, for example, to move a window vent between open and closed positions relative to a window frame. The vent operator assemblies may also lock and unlock the window vent relative to the window frame. In projection-type window assemblies, first and second hinge assemblies may be disposed on respective first and second vertically extending sides of the window vent, and the operator assembly may be disposed on a horizontally extending side of the window frame. In casement-type window assemblies, first and second hinge assemblies may be disposed on respective upper and lower horizontally extending sides of the window vent, and the operator assembly may be disposed on a vertically extending side of the window frame.

### SUMMARY

This section provides a general summary of the disclosure and is not a comprehensive disclosure of its full scope or all of its features.

The present disclosure provides a vent window operator for moving a window vent relative to a window frame that includes a drive assembly having a rotatable drive arm and shoe assembly adaptable for a variety of vent window applications. The vent window operator can include a base, the drive assembly, and an actuator.

In one example, a drive assembly for a vent window operator can include a rotatable drive arm moveable between at least a closed position and an open position and a shoe assembly. The rotatable drive arm can have a driver and an arm member. The arm member can extend between a proximal end and a distal end, and have a mounting aperture located near the distal end. The shoe assembly can be pivotally attached to the arm member at the mounting aperture. The shoe assembly, therefore, can be pivotal relative to the arm member about a pivot axis that is normal to the arm member. The shoe assembly includes a shoe adapted to slide along a track of a window vent and a hinge. The hinge has a first hinge leaf coupled to a second hinge leaf by a hinge pin such that the first hinge leaf is rotatable relative to the second hinge leaf about a pin axis of the hinge pin. The first hinge leaf is attached to the shoe and the second hinge leaf is pivotally attached to the arm member. The first hinge leaf is pivotable relative to the arm member about the pivot axis.

In another aspect, the arm member has a first arm and a second arm. The first arm extends along a first longitudinal axis between a first proximal end and a first distal end. The second arm extends along a second longitudinal axis between a second proximal end and a second distal end. The second proximal end of the second arm is attached to the first distal end of the first arm. The first longitudinal axis and the second longitudinal axis form an included angle and a value of the included angle is selectable from among a plurality of values. The plurality of values can include 0 degrees, 15 degrees and 30 degrees. The shoe assembly is pivotally attached to the second distal end of the second arm and pivotable relative to the second arm about the pivot axis.

In still another aspect, the arm member includes a first arm and a second arm. The first arm extends along a first longitudinal axis between a first proximal end and a first distal end and has a plurality of first mounting apertures located nearer the distal end. The second arm extends along a second longitudinal axis between a second proximal end and a second distal end and has a plurality of second mounting apertures and a plurality of third mounting apertures located nearer the second proximal end of the second arm. At least two of the plurality of third mounting apertures are offset from one another in a direction generally laterally of the second longitudinal axis.

In another aspect of the disclosure, the second proximal end of the second arm is attached to the first distal end of the first arm by a plurality of fasteners. A fastener of the plurality of fasteners is disposed in an aperture of the plurality of first mounting apertures and an aperture of the plurality of second mounting apertures. Another fastener of the plurality of fasteners is disposed in another aperture of the plurality of first mounting apertures and an aperture of the plurality of third mounting apertures. The shoe assembly is pivotally attached to the second distal end of the second arm and is pivotable relative to the second arm about the pivot axis. The first longitudinal axis and the second longitudinal axis can further form an included angle that is selectable from among a plurality of values, including 0 degrees, 15 degrees and 30 degrees.

In a further aspect of the disclosure, the first hinge leaf can include a recessed portion and the second hinge leaf can nest within the recessed portion of the first hinge leaf.

Still further, the first hinge leaf has a first length extending from the pin axis to a distal end of the first hinge leaf and the first length of the first hinge leaf is selectable from a plurality of first length values. The first hinge leaf can additionally include at least one shoe mounting aperture near the distal end of the first hinge leaf. The shoe can be attached to the first hinge leaf at the at least one shoe mounting aperture. The second hinge leaf can have a second length extending from the pin axis to a distal end of the second hinge leaf and each of the plurality of first length values of the first hinge leaf are equal to or greater than the second length of the second hinge leaf.

In yet another aspect of the disclosure, a vent window operator for moving a window vent relative to a window frame can incorporate any of the drive assemblies, and include a base, an actuator. The drive assembly can be received in the base.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings.

FIG. 1 is a perspective view of an exemplary window assembly having a vent operator assembly;

FIG. 2 is a cross-sectional view of the window assembly of FIG. 1;

FIG. 3 is a plan view of the vent operator assembly of FIG. 1 in a closed and locked position;

FIG. 4 is a plan view of the vent operator assembly of FIG. 1 in a closed and unlocked position;

FIG. 5 is a plan view of the vent operator assembly of FIG. 1 in an opened and unlocked position;

FIG. 5A is a partially exploded view of the configuration of FIG. 5;

FIG. 6 is a top-right perspective view of a vent operator assembly including an exemplary arm and shoe assembly according to the principles of the present disclosure;

FIG. 7 is a top plan view of the vent operator assembly of FIG. 6;

FIG. 8 is a partial bottom plan view of a portion of the arm and shoe assembly for a vent operator assembly of FIG. 6;

FIG. 9 is a partial perspective view of an end portion of the arm and shoe assembly of FIG. 6 and showing the shoe assembly in a rotated position;

FIG. 10 an exploded perspective view of the arm and shoe assembly of FIG. 6;

FIG. 11A is a top perspective view of another exemplary arm and shoe assembly according to the principles of the present disclosure and including the shoe assembly in a first position;

FIG. 11B is a bottom perspective view of the arm and shoe assembly of FIG. 11A;

FIG. 11C is a top perspective view of the front of the arm and shoe assembly of FIG. 11A and including the shoe assembly in a second position;

FIG. 11D is a top perspective view of the arm and shoe assembly of FIG. 11A and including the shoe assembly in a third position;

FIG. 12 is a partial perspective view of an end portion of the arm and shoe assembly of FIGS. 11A-11D and showing the shoe assembly in a rotated position;

FIG. 13 is an exploded perspective top view of the arm and shoe assembly of FIGS. 11A-11D;

FIG. 14 is an exploded perspective bottom view of arm and shoe assembly of FIGS. 11A-11D; and

FIG. 15 is perspective bottom view of the of the shoe assembly of the arm and shoe assembly of FIGS. 11A-11D.

In the drawings, reference numbers may be reused to identify similar and/or identical elements in the various figures.

### DETAILED DESCRIPTION

Example embodiments will now be described more fully with reference to the accompanying drawings.

The present disclosure provides a drive assembly for a vent window operator including a rotatable drive arm moveable between at least a closed position and an open position and that can be adapted for a variety of vent windows and ranges of vent opening angles and opening distances. An exemplary vent window operator that can incorporate the drive assembly of the present disclosure may be understood from U.S. Pat. No. 10,309,144 entitled “Vent Operator” and assigned to the Applicant. The entire disclosure of U.S. Pat. No. 10,309,144 is hereby incorporated by reference.

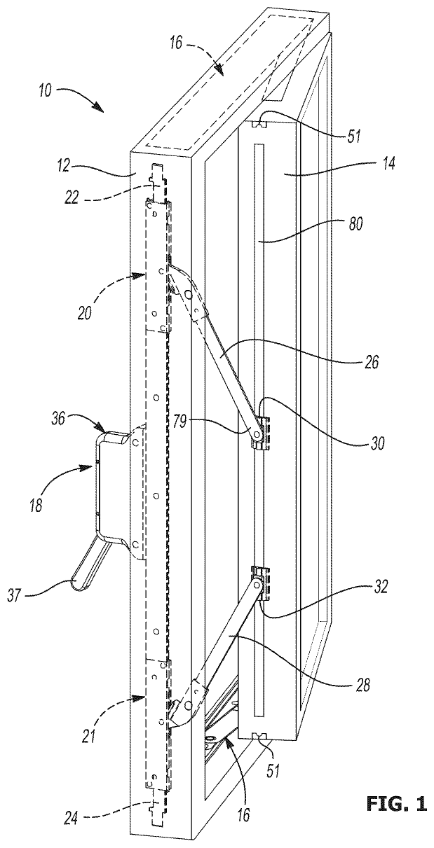

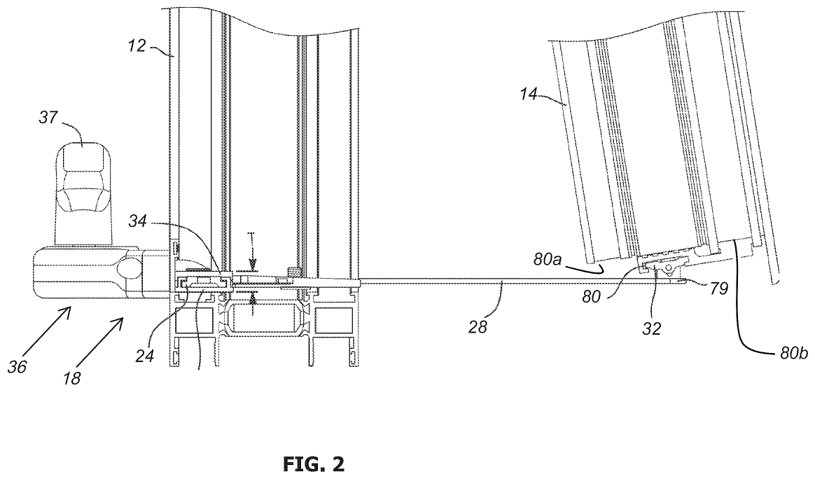

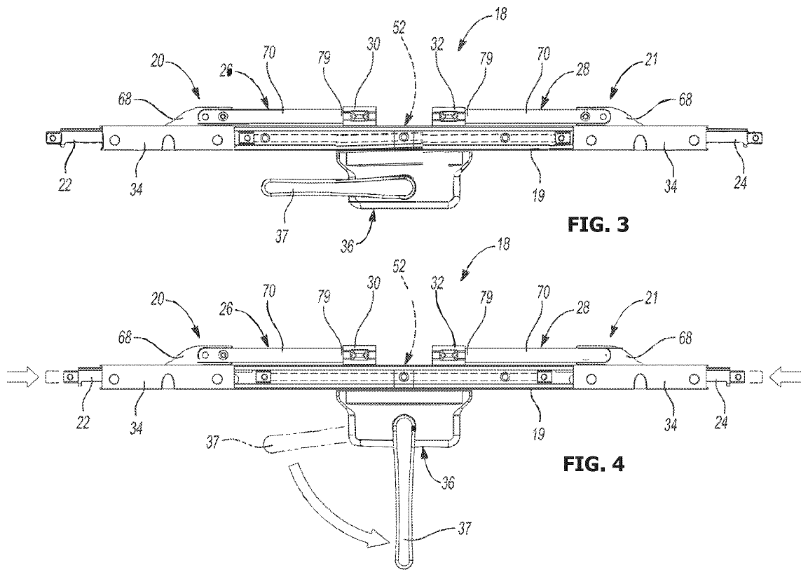

With reference to FIGS. 1 and 2, a window assembly 10 is provided that may include a window frame 12, a window vent 14, a pair of hinge assemblies 16, and a vent operator assembly 18. The vent operator assembly 18 and hinge assemblies 16 allow the window vent 14 to move relative to the window frame 12 between an open position (FIGS. 1, 2 and 5) and a closed position (FIGS. 3 and 4). The window assembly 10 shown in FIG. 1 is a casement-type window assembly. Therefore, the hinge assemblies 16 is disposed on horizontally extending sides of the window vent 14 and the vent operator assembly 18 is disposed on a vertically extending side of the window frame 12. However, it will be appreciated that the hinge assemblies 16 and vent operator assembly 18 could be incorporated into other types of window assemblies, such as a projection-type window assembly, for example.

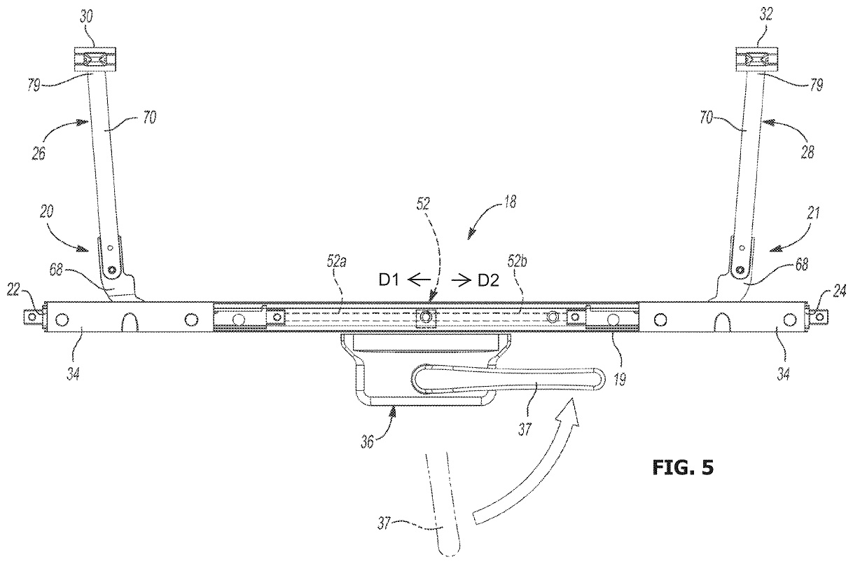

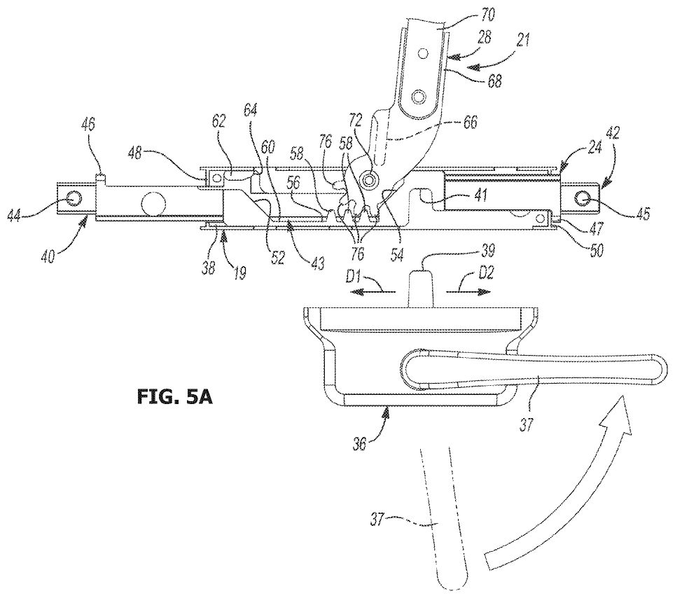

Referring now to FIGS. 1-5, the vent operator assembly 18 may include a base 19, first and second drive assemblies 20, 21, and an actuator assembly 36. The first and second drive assemblies 20, 21 may include first and second drive members 22, 24, first and second rotatable drive arms 26, 28, first and second slide members or shoe assemblies 30, 32, and one or more cover members 34. As will be described in more detail below, a user may rotate a handle 37 of the actuator assembly 36 among a first position (FIG. 3) in which the window vent 14 is closed and locked relative to the window frame 12, a second position (FIG. 4) in which the window is closed but unlocked from the window frame 12, and a third position (FIG. 5) in which the window vent 14 is open and unlocked from the window frame 12.

The base 19 may be mounted to the window frame 12 and may include a track or channel 38 in which the first and second drive members 22, 24 are slidably received. The cover members 34 may fixedly engage the base 19 to retain the drive members 22, 24 and the drive arms 26, 28 therebetween while still allowing movement of the drive members 22, 24 and the drive arms 26, 28 relative to the cover members 34 and base 19.

The first and second drive members 22, 24 may be substantially mirror images of each other, but otherwise substantially similar or identical. Therefore it will be appreciated that the first drive member 22 may include features that are identical mirror-images of the features of the second drive member 24. The drive members 22, 24 may each include first and second ends 40, 42 and a central recessed portion 43. The first and second ends 40, 42 may include first and second pegs 44, 45, respectively, and first and second stop tabs 46, 47, respectively. Interference between the first stop tab 46 and a first stop surface 48 of the base 19 and interference between the second stop tab 47 and a second stop surface 50 of the base 19 may limit the travel of the drive members 22, 24 relative to the base 19.

The first pegs 44 may engage a linkage 52 (shown schematically in FIGS. 1-5) of the actuator assembly 36 such that rotation of the handle 37 of the actuator assembly 36 causes corresponding linear sliding motion of the drive members 22, 24 relative to the base 19. When the handle 37 is in the first position shown in FIG. 3, the second pegs 45 may engage corresponding locking slots 51 (show schematically in FIG. 1) in the window vent 14 to lock the window vent 14 relative to the window frame 12. When the handle 37 is in the second or third position (FIGS. 4 and 5), the second pegs 45 are disengaged from the locking slots, thereby unlocking the window vent 14 from the window frame 12 to allow movement of the window vent 14 relative to the window frame 12.

As described in U.S. Pat. No. 10,309,144, the central recessed portion 43 of the drive members 22, 24 may include first and second ramped surfaces 52, 54 and a bottom surface 56 disposed between the first and second ramped surfaces 52, 54. As shown in FIGS. 3-5, a portion of the drive arms 26, 28 may be movably received in the central recessed portion 43. A plurality of rack teeth 58 may extend from the bottom surface 56 adjacent the second ramped surface 54 and spaced apart from the first ramped surface 52. That is, the bottom surface 56 includes a flat portion 60 between the rack teeth 58 and the first ramped surface 52. In some embodiments, the flat portion 60 may have a length approximately equal to or greater than a distance between the first and second ramped surfaces 52, 54. In other embodiments, the length of the flat portion could be less than half of the distance between the first and second ramped surfaces 52, 54. As shown in FIGS. 3-5, a portion of the drive arms 26, 28 may be received in the central recessed portion 43.

The central recessed portion 43 may also include a tab 62 located proximate the first ramped surface 52. The tab 62 may include a tapered end 64. As will be described in more detail below, the tab 62 may be slidably received in a slot 66 in the corresponding arm 26, 28 when the handle 37 of the actuator assembly 36 is in the first position and between the first and second positions.

The first and second drive arms 26, 28 can also be substantially identical mirror-images of each other. The drive arms 26, 28 may include a first portion or driver 68 and a second portion or arm member 70. The first portion 68 of each arm 26, 28 may include a rotation aperture 72 that receives a rotation pin 74 that extends between the base 19 and cover 34 and defines an axis about which the arm 26, 28 rotates relative to the base 19. The rotation pin 74 can be integrally formed with the cover 34. The slot 66 that slidably receives the tab 62 of the drive member 22, 24 is formed in the first portion 68. The first portion 68 may also include pinion portion including a plurality of gear teeth 76 arranged in a curved pattern around the rotation aperture 72. The gear teeth 76 can meshingly engage the rack teeth 58 of the drive members 22, 24. One of the gear teeth 76 can slide along the flat portion 60 of the central recessed portion 43 of the drive members 22, 24 when the handle 37 is moved between the first and second positions.

The second portion 70 of each arm 26, 28 may be partially received in a recess 78 in the first portion 68 and fixed to the first portion 68 by one or more fasteners. Forming the drive arms 26, 28 from the discrete first and second portions 68, 70 allows for the vent operator assembly 18 to be used with second portions 70 of a desired length to suit a given application. For example, in commercial or industrial window applications, a second portion 70 may be chosen that has a length that allows for a relatively smaller amount of travel of the window vent 14 between the open and closed positions (i.e., a smaller angle between the vent 14 and frame 12 in the fully open position). In residential window applications, a second portion 70 may be chosen that has a length that allows for a relatively larger amount of travel of the window vent 14 between the open and closed positions (i.e., a larger angle between the vent 14 and frame 12 in the fully open position). In some embodiments, the first and second portions 68, 70 could be integrally formed as a unitary body.

The first and second shoe assemblies 30, 32 may pivotably engage ends 79 of the second portions 70 of the drive arms 26, 28, respectively. As the handle 37 of the actuator assembly 36 moves between the second and third positions (FIGS. 4 and 5), the shoe assemblies 30, 32 slide along a track 80, 80a, 80b (FIGS. 1 and 2) of the window vent 14 in FIG. 2, the track 80 is provided by an adapter.

With continued reference to FIGS. 1-5, operation of the window assembly 10 will be described in detail. As described above, a user may rotate the handle 37 of the actuator assembly 36 between the positions shown in FIGS. 3 and 5 to move the vent operator assembly 18 and the window vent 14 between (1) a closed and locked position shown in FIG. 3; (2) a closed and unlocked position shown in FIG. 4; and (3) an open and unlocked position shown in FIG. 5. Rotation of the handle 37 causes corresponding linear motion of the first and second drive members 22, 24 toward and away from the center of the base 19. As shown in FIGS. 3-5, only a portion of the linear travel of the drive members 22, 24 causes corresponding rotation of the drive arms 26, 28 and rotation of the window vent 14 relative to the window frame 12. That is, the motion of the drive members 22, 24 caused by a first stage of rotation of the handle 37 between the first position (FIG. 3) and the second position (FIG. 4) moves the drive members 22, 24 out of engagement with the locking slots 51 of the window vent 14 (i.e., to unlock the window vent 14 from the window frame 12) and does not move the drive arms 26, 28 or the window vent 14 relative to the frame 12. The drive arms 26, 28 and window vent 14 only move in response to a second stage of movement of the handle 37 between the second and third positions (FIGS. 4 and 5). This staged movement of the vent operator assembly 18 (i.e., moving the drive arms 26, 28 and window vent 14 in one stage and locking or unlocking the window vent 14 to the frame 12 in another separate stage) eliminates binding or jamming that can occur in mechanisms that simultaneously close and lock a window vent.

Starting from the closed and locked position shown in FIG. 3, rotation of the handle 37 from the first position (FIG. 3) to the second position (FIG. 4) causes the first and second drive members 22, 24 to move relative to the base 19 and cover 34 in linear directions toward each other. This first stage of linear motion of the drive members 22, 24 causes the flat portion 60 of the central recessed portion 43 to slide along one of the gear teeth 76 of the drive arms 26, 28 (without rotating the drive arms 26, 28) until one of the gear teeth 76 contacts one of the rack teeth 58 of the drive members 22, 24 when the handle 37 reaches the second position.

Thereafter, continued rotation of the handle 37 from the second position toward the third position (FIG. 5) causes the drive members 22, 24 to continue to move relative to the base 19 and cover 34 in linear paths toward each other, thereby causing the rack teeth 58 of the drive members 22, 24 to drivingly engage the gear teeth 76 of the drive arms 26, 28 and rotate the drive arms 26, 28 to the fully open position shown in FIG. 4.

In the fully open position, the drive arms 26, 28 may be angled relative to each other rather than parallel to each other. That is, the drive arms 26, 28 may rotate more than ninety degrees between the fully closed position (FIGS. 2 and 3) and the fully open position (FIG. 4). In this manner, a force applied to the window vent 14 (such as wind, for example) biasing the window vent 14 toward the closed position will tend to urge the drive arms 26, 28 further away from the closed position rather than urging the drive arms 26, 28 toward the closed position (as described above, the stop tabs 47 of the drive members 22, 24 would prevent any further motion of the drive arms 26, 28 away from the closed position from the fully open position). Therefore, the orientation of the drive arms 26, 28 in the fully open position prevents the window vent 14 from being inadvertently closed by a gust of wind or some other external force.

To close the window vent 14, the handle 37 may be rotated from the third position (FIG. 4) toward the second position (FIG. 3). Such rotation of the handle 37 causes the drive members 22, 24 to slide linearly away from each other and causes the rack teeth 58 to rotate the drive arms 26, 28 back toward the closed position shown in FIG. 3. As the drive members 22, 24 and drive arms 26, 28 move into the closed position the tapered end 64 of the tab 62 of the drive members 22, 24 may slightly interfere with a surface 84 defining the opening to the slot 66 in the drive arms 26, 28. The tapered shapes of the surface 84 and the tapered end 64 of the tab 62 may cause the drive arms 26, 28 to shift relative to the rotation pin 74 about which the drive arms 26, 28 rotate. That is, the relatively large diameter of the rotation aperture 72 compared to the relatively smaller diameter of the rotation pin 74 allows for the shifting of the drive arms 26, 28 to allow the tab 62 to be received into the slot 66.

The structure of the drive assemblies 20, 21 described herein and shown in the figures allows the thickness T (FIG. 2) of the drive assemblies 20, 21 to be thin enough (in some examples, the thickness T may be about 0.625 inches thick or less) to provide clearance for the window vent 14 to move into a closed position in which the window vent 14 is seated against the frame 12 without interfering with the drive assemblies 20, 21 and without having to flex or shift the drive assemblies 20, 21 out of the way.

While the vent operator assembly 18 depicted in the figures includes two drive arms 26, 28 and the actuator assembly 36 disposed midway between the drive arms 26, 28, in some embodiments, the actuator assembly 36 could be disposed off-center (i.e., closer to one of the drive arms 26, 28 than the other). With the actuator assembly 36 midway between the drive assemblies 20, 21 (as shown in FIG. 4), links 52a, 52b are substantially equal in length. To change the configuration of the vent operator assembly 18 so that the actuator assembly 36 is off-center, the only modification that needs to be made is to replace the links 52a, 52b shown in FIG. 4 with links 52a, 52b having different lengths (i.e., link 52a could be shorter and link 52b could be longer or vice versa). This provides for flexibility in locating the handle 37 anywhere along the frame 12.

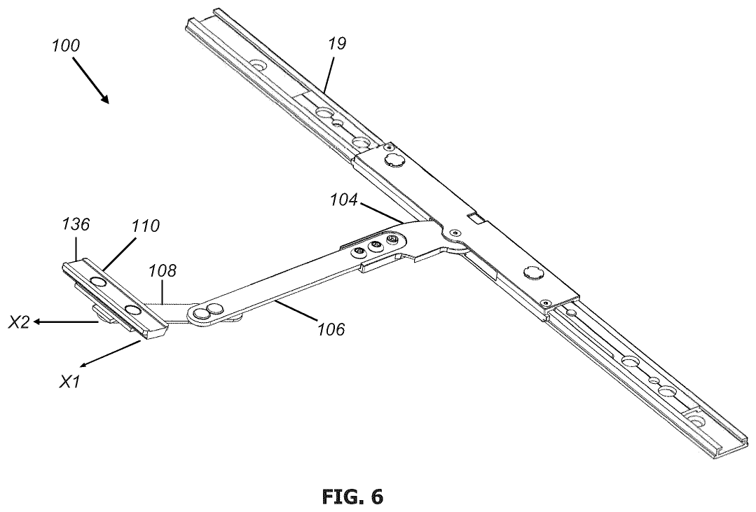

In some embodiments, the vent operator assembly 18 could include only a single drive assembly 20, 21 having (as shown, e.g., in FIG. 6) rather than two drive assemblies 20, 21 (as shown in FIGS. 1, 3, 4 and 5). In such embodiments, a tab 39 driven by the handle 37 may be received directly in a slot or notch 41 in the drive member 24. Rotation of the handle 37 causes the tab 39 to move linearly left and right in directions D1 and D2, thereby moving the drive member 24 to the left and right in directions D1 and D2 to operate the vent operator assembly 18 as described above.

With reference to FIGS. 6-10 a vent operator assembly 18 can include drive assembly incorporating a rotatable drive arm having a driver 104, an adaptable arm 100 and a shoe assembly 110 according to the principles of the present disclosure. More specifically the first and/or second drive assemblies 20, 21 of the vent operator assembly 18 may incorporate the adaptable arm 100 and the shoe assembly 110. The adaptable arm 100 is compatible with a variety of window vents, such as to accommodate window vents of different depths, and applications of varying travel of the window vent 14 between the open and closed positions. In addition, the adaptable arm 100 offers manufacturing efficiencies which are explained in greater detail below.

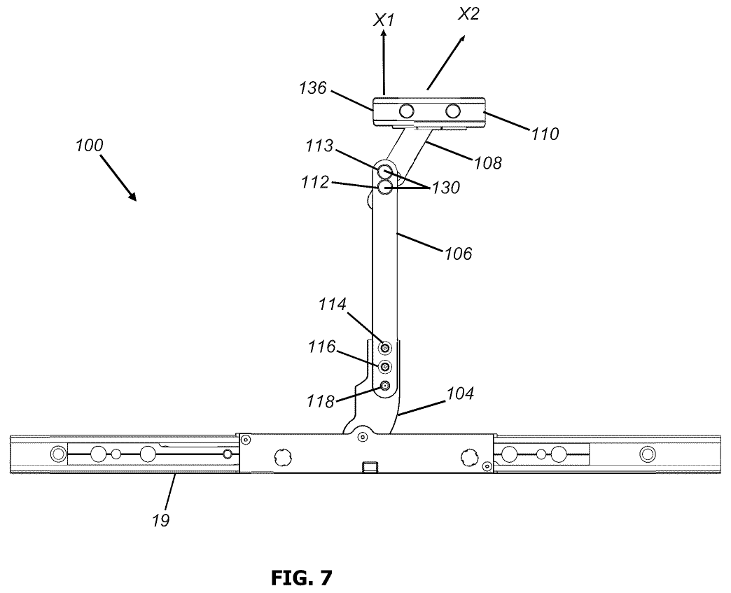

The adaptable arm 100 is disposed at the distal end of the driver 104. In one aspect, the adaptable arm 100 may include a flex arm 106 and an offset arm 108. A shoe assembly 110 may be attached to a distal end of the offset arm 108 (shown in FIGS. 6 and 7).

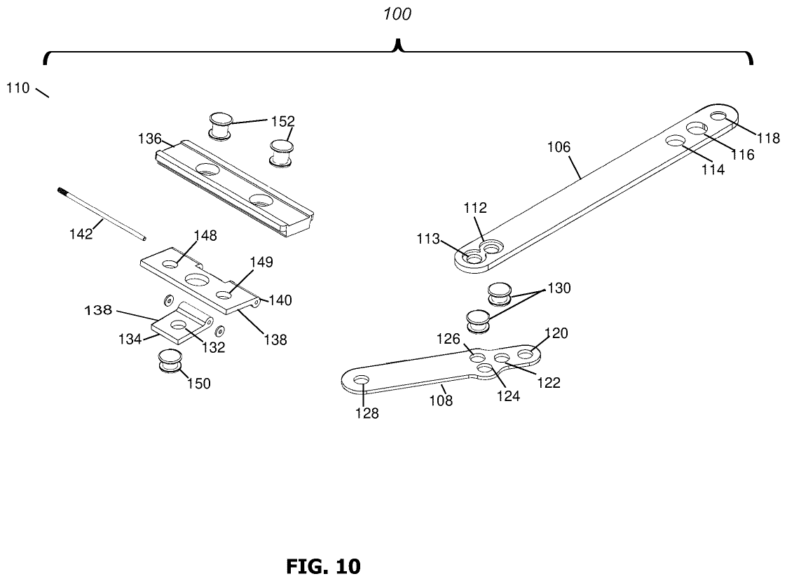

The flex arm 106 is adapted to attach to a rotatable driver 104 of the drive assembly 20, 21. The flex arm 106 may include a first, flat generally bar-shaped member having a substantially rectangular cross-section and extending along a first longitudinal axis X1 between a first proximal end and a first distal end. The flex arm 106 may further include a plurality of mounting apertures 112-118 (best seen in FIG. 10), with mounting apertures 114, 116, 118 located nearer the proximal end to facilitate attaching the flex arm 106 to the driver 104 and mounting apertures 112, 113 located nearer the distal end to facilitate attaching the offset arm 108 to the flex arm 106. In an open position, the flex arm 106 is generally perpendicular to the base 19 and in a closed position, the flex arm 106 is generally parallel to the base 19. The drive assembly 20, 21 may include a rotation angle α of up to about 90 degrees between the open position and the closed position.

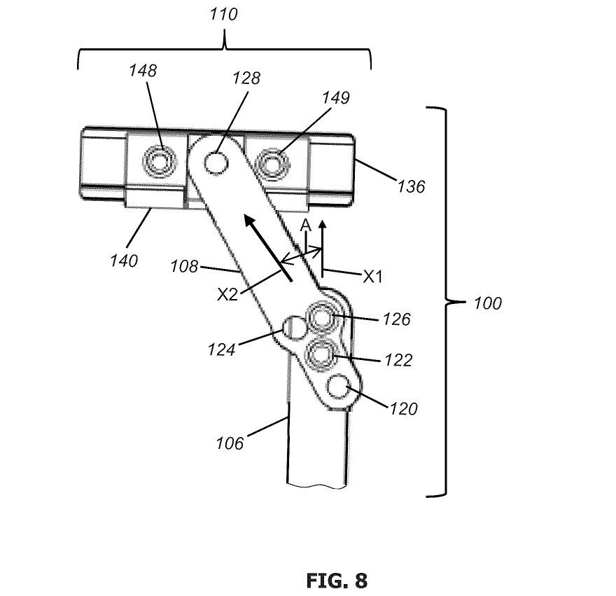

As shown in FIG. 8, the offset arm 108 is adapted to attach at or near the distal end of the flex arm 106. The offset arm 108 may include a second, flat generally bar-shaped member extending along a second longitudinal axis X2 between a second proximal end and a second distal end. The offset arm 108 may further include mounting apertures 120, 122 and a plurality of mounting apertures 124, 126, each located nearer the second proximal end of the offset arm 108 to facilitate attaching the offset arm 108 to the flex arm 106. In addition, at least one mounting aperture 128 is located nearer the second distal end of the offset arm 108 to facilitate attaching the shoe assembly 110 to the offset arm 108. The mounting apertures 124, 126 may be offset from one another in a direction generally laterally of the second longitudinal axis X2.

The mounting apertures 120-128 of the offset arm 108 allow the flex arm 106 and offset arm 108 to be attached to one another at different offset angles by a plurality of fasteners 130. When attached, the offset arm 108 and the flex arm 106 can form an included angle (A) between the second longitudinal axis X2 and the first longitudinal axis X1, wherein a value of the included angle (A) is selectable from a plurality of values. For example, the included angle (A) can be selected from between 0 degrees, 15 degrees, and 30 degrees. That is, the included angle (A) between X1 and X2 can vary. This allows the adaptable arm 100 to accommodate a greater range of window depths and/or different window vent mounting locations (e.g., outer track 80b or inner track 80a) and/or different window vent opening travel between the closed and opened positions while using a single offset arm 108.

By arranging fasteners in the various mounting apertures 120-128 of the offset arm 108, different offset angles can be achieved. For example, by attaching fasteners at mounting apertures 120 and 122, a 0 degree angle can be achieved wherein the longitudinal axis X2 of the offset arm 108 is aligned with the longitudinal axis X1 of the flex arm 106. Similarly, by attaching fasteners at the mounting apertures 122 and 124 or at the mounting apertures 122 and 126, a 15 degree angle and a 30 degree angle can be achieved, respectively. Of course, the number and positions of the mounting apertures can be varied to achieve many different offset angles.

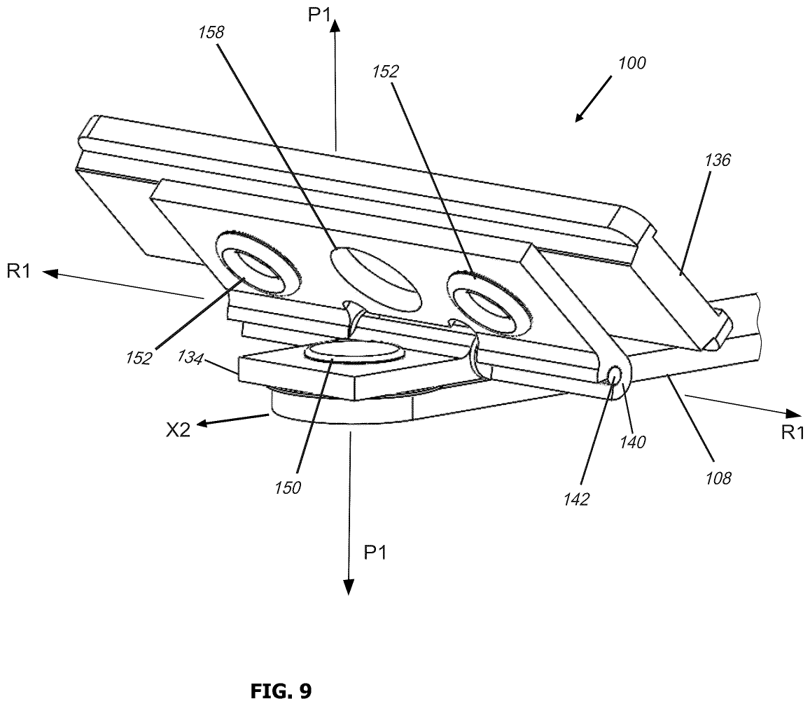

The shoe assembly 110 is adapted to attach to the distal end of the offset arm 108. The shoe assembly 110 may include a shoe 136 adapted to slide along a track 80 of the window vent 14, a hinge 138 comprising a first hinge leaf 140 attached to the shoe 136 and coupled via pin 142 to a second hinge leaf 134 pivotally attached to the distal end of the offset arm 108 (shown in FIG. 9). The first hinge leaf 140 may comprise an aperture 158 that allows clearance for fastener 150 permitting the hinge 138 to close flat with the first hinge leaf 140 on top of and/or adjacent to the second hinge leaf 134.

The rotation axis R1 defined by the pin 142 and the pivot axis P1 (i.e., via the fastener 150) of the shoe assembly 110 (see, e.g., FIG. 9) further allows the adaptable arm 100 to accommodate a greater range of window vent depths, mounting locations on the window vent 14 and mounting angles. The hinge 138, operating about the rotation axis R1, permits the shoe 136 to remain attached to the window vent 14 during the opening and closing process when the angle of attachment between the shoe assembly 110 and the window vent 14 may vary.

FIG. 10 illustrates an exploded view of the adaptable arm 100, including components described throughout the specification and further illustrating a plurality of fasteners 130 configured to attach the flex arm 106 to the offset arm 108, a single fastener 150 configured to pivotally attach the offset arm 108 to the second hinge leaf 134, and a plurality of fasteners 152 configured to attach the first hinge leaf 140 to the shoe 136.

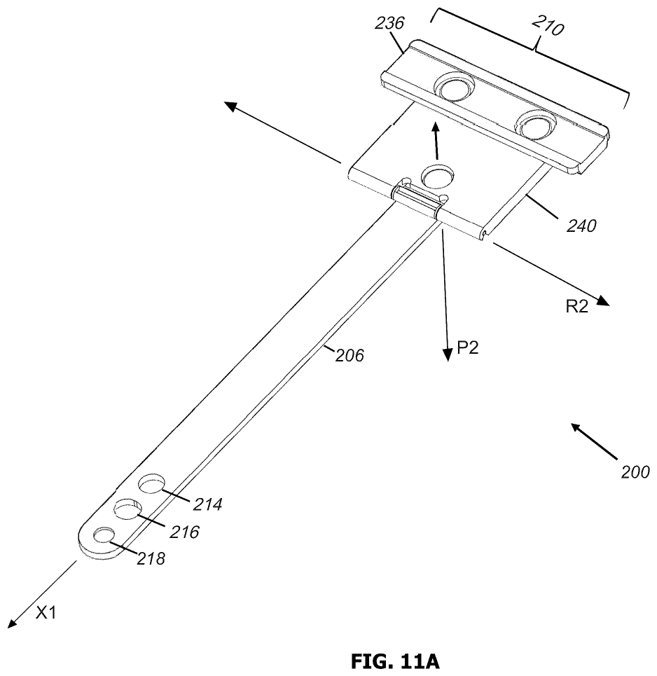

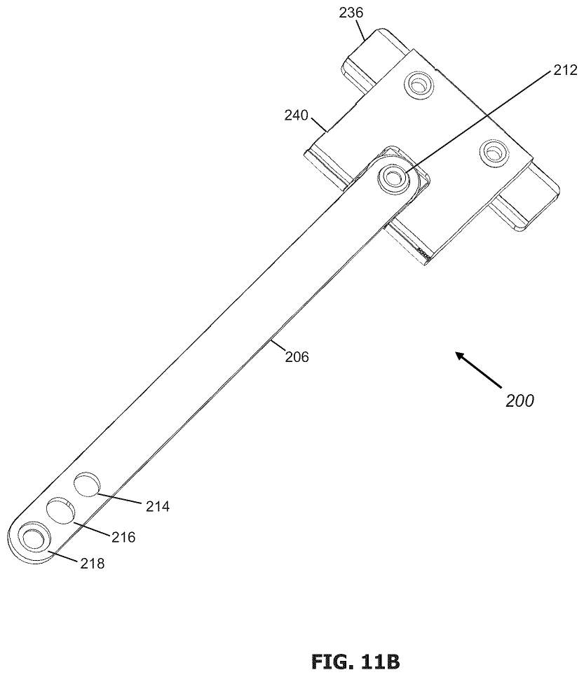

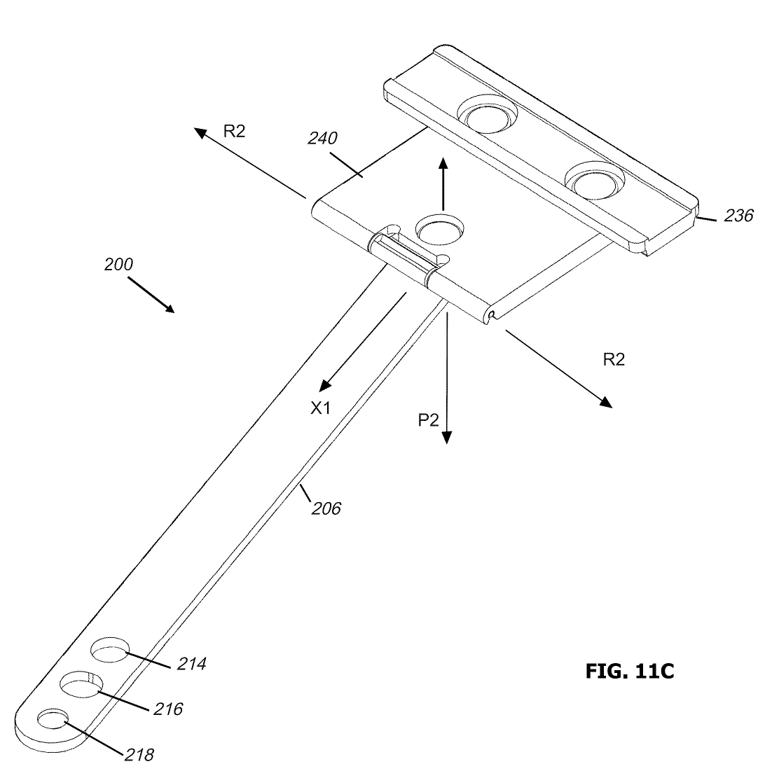

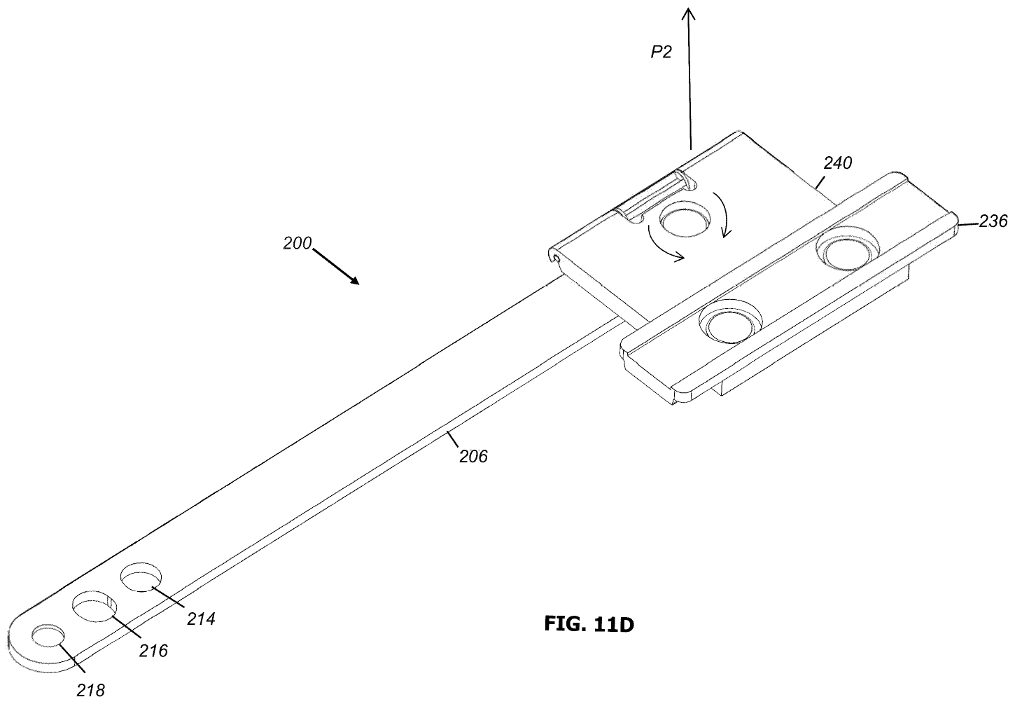

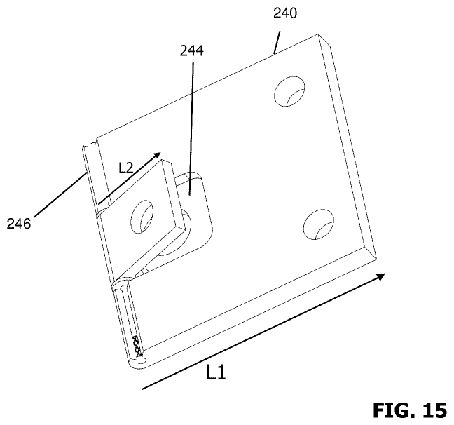

A second embodiment of the adaptable arm 200 is shown in FIGS. 11-15. In this embodiment, a flex arm 206 may include a plurality of first mounting apertures 214, 216, 218 located nearer the proximal end to facilitate attaching the flex arm 206 to the driver 104 and a single mounting aperture 212 located nearer the distal end to facilitate pivotally attaching the flex arm 206 to the second hinge leaf 234 of the shoe assembly 210 (e.g., via the fastener 250 and the mounting aperture 232). As in the adaptable arm 100 shown in FIGS. 6-10, the flex arm 206 is generally perpendicular to the base 19 in the open position and the flex arm 206 is generally parallel to the base 19 in the closed position.

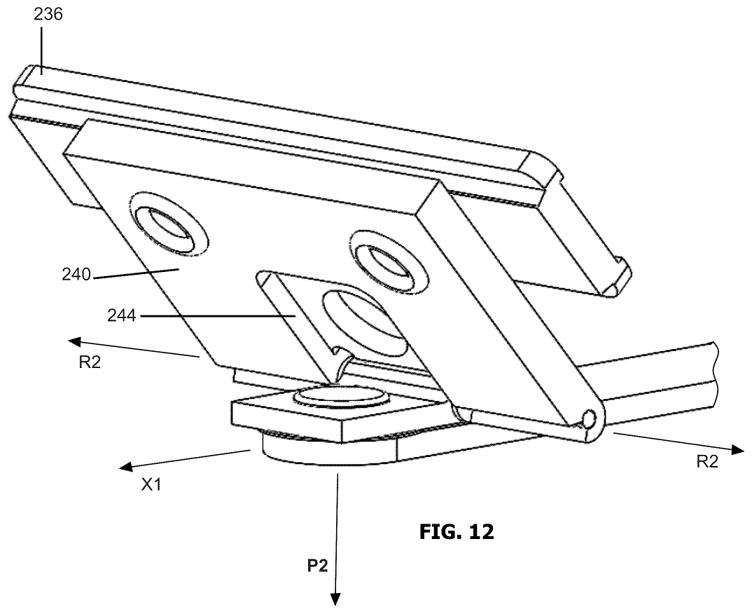

In the adaptable arm 200 of FIGS. 11-15, a pivot axis P2 is defined about the fastener 250 in the mounting aperture 212, as illustrated in FIGS. 11-12. The shoe assembly 210 may pivot laterally in the horizontal plane of the flex arm 206 up to 180 degrees β about the pivot axis P2. This allows the shoe assembly, once attached to the window frame 12, to pivot with the motion of the window vent 14 between open and closed positions regardless of the angle of travel.

The first hinge leaf 240 is rotatable relative to the second hinge leaf 234 about a rotation axis R2 defined by a pin 242 that couples the first hinge leaf 240 to the second hinge leaf 234, such that the shoe 236 can rotate about the axis R2 relative to the flex arm 206 (FIGS. 11-12).

The first hinge leaf 240 may vary in its length L1, the dimension from the end of the first hinge leaf 240 nearest the pin 242 and the distal end of the first hinge leaf 240. The length L1 of the first hinge leaf may be the same or greater than a corresponding length L2 of the second hinge leaf 234 (FIGS. 11-12 and FIG. 15). The first hinge leaf may be resized to a length L1 suitable for operation by trimming the distal end of the first hinge leaf 240. Varying the length L1 of the first hinge leaf 240 allows the adaptable arm 200 to be adapted to a greater variety of vent window assemblies and a greater range of vent opening angles. This also provides a manufacturing advantage as a manufacturer need only produce a single hinge leaf of a maximum length that can then be trimmed to a desired length to accommodate a given vent window application. This provides a further advantage to the manufacturer by reducing the need to produce and maintain inventory of a variety of shoe adapters as a standard shoe adapter may be attached to hinge leaves of varying length instead.

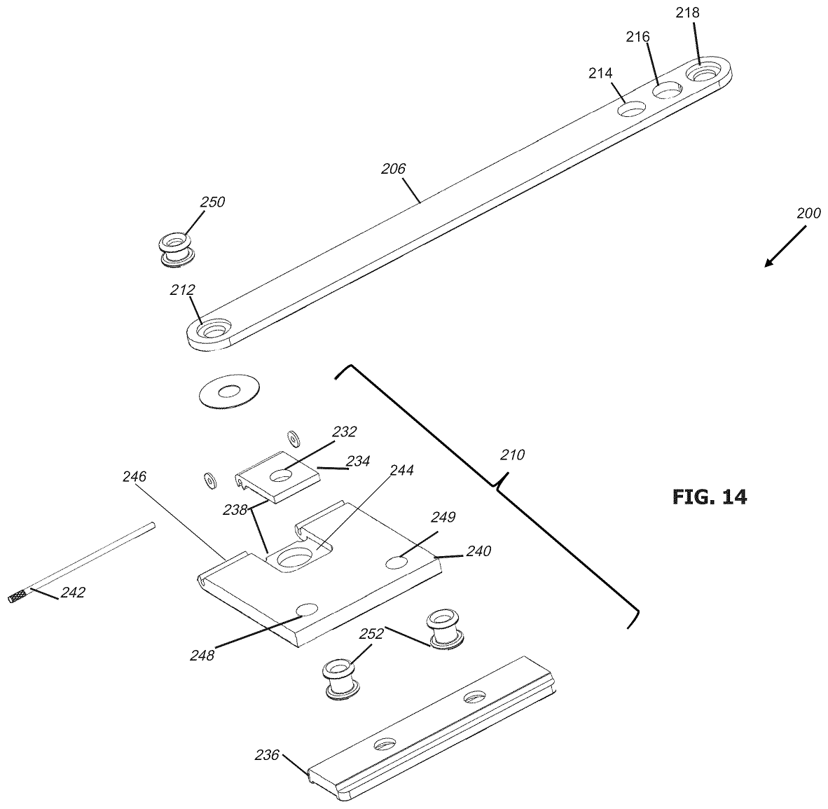

The first hinge leaf 240 may further include a recessed portion 244 and the second hinge leaf 234 may be configured to be nested within the recessed portion 244 of the first hinge leaf 240. The first hinge leaf 240 may further include a notched barrel 246 design. The recessed portion 244 and notched barrel 246 of the first hinge leaf 240 is best shown in FIG. 14.

The first hinge leaf 240 may further include at least one shoe mounting aperture 248, 249 at the distal end of the first hinge leaf 240. The shoe mounting aperture 248, 249 is configured to attach shoe 236 that is adapted to slide along a track 80, 80a, 80b of the window vent 14.

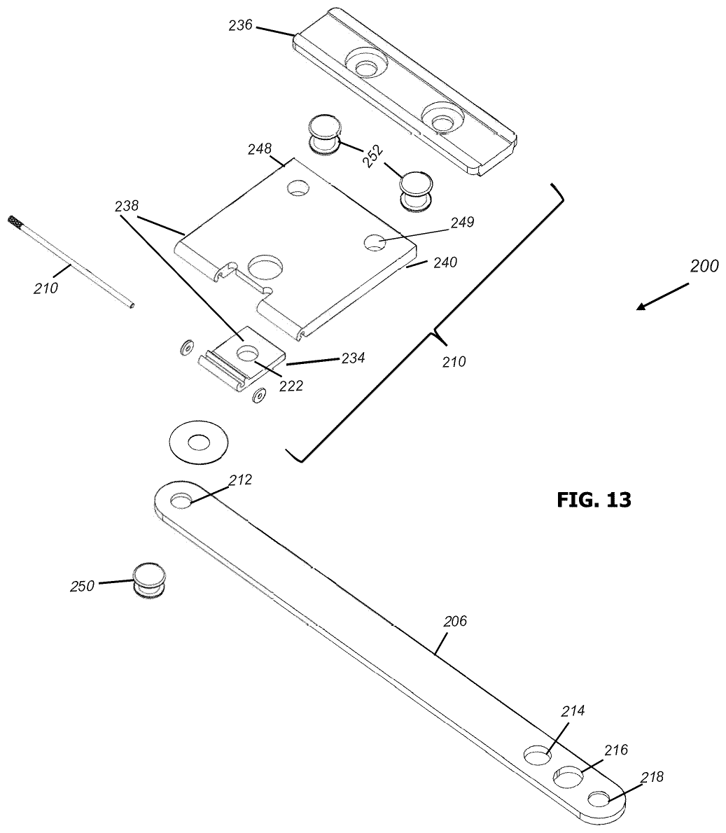

FIG. 13 illustrates an exploded perspective top view of the adaptable arm 100 of FIGS. 11A-11D and FIG. 14 illustrates an exploded perspective bottom view of the adaptable arm 100 of FIGS. 11A-11D including components described throughout the specification and further shows at least one fastener 250 configured to pivotally attach the flex arm 206 to the second hinge leaf 234 and a plurality of fasteners 252 configured to attach the first hinge leaf 240 and the shoe 236. The fasteners may be screws, rivets, or similar means for fastening.

The adaptable arms 100, 200 of the above embodiments provide various advantages, including a greater degree of compatibility with window vents of various sizes, depths, and mounting angles. Further, the adjustable offset arm 108 of the adaptable arm 100 shown in FIGS. 6-10 and the adaptable hinge leaf 240 of the adaptable arm 200 shown in FIGS. 11-15 provide manufacturing and inventory management advantages by reducing the number of components required to achieve a broad compatibility with a diverse array of window vents and window vent applications.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. A drive assembly comprising:
a rotatable drive arm for a vent window operator moveable between at least a closed position and an open position and comprising a driver and an arm member;
wherein the arm member extends between a proximal end and a distal end, and comprises a mounting aperture located near the distal end; and
a shoe assembly pivotally attached to the arm member at the mounting aperture wherein the shoe assembly is pivotal relative to the arm member about a pivot axis that is normal to the arm member;
wherein the shoe assembly comprises a shoe adapted to slide along a track of a window vent and a hinge;
wherein the hinge comprises a first hinge leaf coupled to a second hinge leaf by a hinge pin such that the first hinge leaf is rotatable relative to the second hinge leaf about a pin axis of the hinge pin; and
wherein the first hinge leaf is attached to the shoe and the second hinge leaf is pivotally attached to the arm member and is pivotable relative to the arm member about the pivot axis.

2. A vent window operator for moving a window vent relative to a window frame, the operator comprising:
a base;
the drive assembly according to claim 1; and
an actuator;
wherein the base is mounted to the window frame;
wherein the drive assembly is received in the base.

3. The drive assembly of claim 1, wherein the arm member comprises a first arm and a second arm;
wherein the first arm extends along a first longitudinal axis between a first proximal end and a first distal end;
wherein the second arm extends along a second longitudinal axis between a second proximal end and a second distal end, the second proximal end of the second arm being attached to the first distal end of the first arm;
wherein the first longitudinal axis and the second longitudinal axis form an included angle;
wherein a value of the included angle is selectable from among a plurality of values;
wherein the shoe assembly is pivotally attached to the second distal end of the second arm and pivotable relative to the second arm about the pivot axis.

4. The drive assembly of claim 3, wherein the plurality of values includes 0 degrees, 15 degrees and 30 degrees.

5. A vent window operator for moving a window vent relative to a window frame, the operator comprising:
a base;
the drive assembly according to claim 3; and
an actuator;
wherein the base is mounted to the window frame;
wherein the drive assembly is received in the base.

6. The drive assembly of claim 1, wherein the arm member comprises a first arm and a second arm;
wherein the first arm extends along a first longitudinal axis between a first proximal end and a first distal end, the first arm comprising a plurality of first mounting apertures located nearer the distal end;
wherein the second arm extends along a second longitudinal axis between a second proximal end and a second distal end, the second arm comprising a plurality of second mounting apertures and a plurality of third mounting apertures located nearer the second proximal end of the second arm;
wherein at least two of the plurality of third mounting apertures are offset from one another in a direction generally laterally of the second longitudinal axis; and
wherein the second proximal end of the second arm is attached to the first distal end of the first arm by a plurality of fasteners;
wherein a fastener of the plurality of fasteners is disposed in an aperture of the plurality of first mounting apertures and an aperture of the plurality of second mounting apertures, and another fastener of the plurality of fasteners is disposed in another aperture of the plurality of first mounting apertures and an aperture of the plurality of third mounting apertures;
wherein the shoe assembly is pivotally attached to the second distal end of the second arm and pivotable relative to the second arm about the pivot axis.

7. The drive assembly of claim 6, wherein the first longitudinal axis and the second longitudinal axis form an included angle;
wherein a value of the included angle is selectable from among a plurality of values.

8. The drive assembly of claim 7, wherein the plurality of values includes 0 degrees, 15 degrees and 30 degrees.

9. A vent window operator for moving a window vent relative to a window frame, the operator comprising:
a base;
the drive assembly according to claim 6; and
an actuator;
wherein the base is mounted to the window frame;
wherein the drive assembly is received in the base.

10. The drive assembly of claim 1, wherein the first hinge leaf comprises a recessed portion formed therein; and
wherein the second hinge leaf is adapted to nest within the recessed portion of the first hinge leaf.

11. A vent window operator for moving a window vent relative to a window frame, the operator comprising:
a base;
the drive assembly according to claim 10; and
an actuator;
wherein the base is mounted to the window frame;
wherein the drive assembly is received in the base.

12. The drive assembly of claim 10, wherein the first hinge leaf comprises a first length extending from the pin axis to a distal end of the first hinge leaf; and
wherein the first length of the first hinge leaf is selectable from a plurality of first length values.

13. The drive assembly of claim 10, wherein the first hinge leaf further comprises at least one shoe mounting aperture near the distal end of the first hinge leaf.

14. The drive assembly of claim 13, wherein the shoe is attached to the first hinge leaf at the at least one shoe mounting aperture.

15. A vent window operator for moving a window vent relative to a window frame, the operator comprising:
a base;
the drive assembly according to claim 14; and
an actuator;
wherein the base is mounted to the window frame;
wherein the drive assembly is received in the base.

16. The drive assembly of claim 12, wherein the second hinge leaf comprises a second length extending from the pin axis to a distal end of the second hinge leaf; and
wherein each of the plurality of first length values is equal to or greater than the second length of the second hinge leaf.

17. The drive assembly of claim 16, wherein the first hinge leaf further comprises at least one shoe mounting aperture near the distal end of the first hinge leaf.

18. The drive assembly of claim 17, wherein the shoe is attached to the first hinge leaf at the at least one shoe mounting aperture.

19. A vent window operator for moving a window vent relative to a window frame, the operator comprising:
a base;
the drive assembly according to claim 18; and
an actuator;
wherein the base is mounted to the window frame;
wherein the drive assembly is received in the base.
